(19) United States
(12) Patent Application Publication
(10) Pub. No.: US 2008/0247404 A1
(43) Pub. Date: Oct. 9, 2008

(54) TELEPHONE SYSTEM AND GATEWAY DEVICE

(75) Inventor: Atsushi Yamazaki, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/048,800

(22) Filed: Mar. 14, 2008

(30) Foreign Application Priority Data
Apr. 3, 2007 (JP) 2007-097624

(51) Int. Cl. H04L 12/66

(52) U.S. Cl. 370/401

(57) ABSTRACT

According to one embodiment, a gateway connects a plurality of telephones to a packet network including a server processes calls using address information, includes a registration processor requires registrations of a plurality of items of address information to be used for call origination to packet network, a table records the plurality of items of address information and results of registrations for each item of address information in packet network, a selection processor confirms the results of the registrations of the address information included in the notified request message from a transmitting origin telephone by referring to the table and selects another item of address information if the relevant address information has not been registered, and a call controller sends a message including address information if the address information included in the request message has been registered, and otherwise, including another information selected from the selection processor to the server.

### CROSS-REFERENCE TO RELATED APPLICATIONS

This application is based upon and claims the benefit of priority from Japanese Patent Application No. 2007-097624, filed Apr. 3, 2007, the entire contents of which are incorporated herein by reference.

### BACKGROUND

1. Field

One embodiment of the present invention relates to a telephone system, for example, using an Internet protocol (IP) technique.

2. Description of the Related Art

A system which achieves voice communication by using a best effort type network such as the Internet has been known. This kind of system is referred to as an IP telephone system or Voice over IP (VoIP), and is applied not only to a local network such as a private telephone network but also a wide area telephone network including call origination and reception to and from an external line.

In many cases, the IP telephone system has a function to give authentication to each telephone. A representative of such a terminal authentication function is registration by use of a session initiation protocol (SIP). This function enables enhancing the independence of an IP telephone (hereinafter referred to as IP terminal) and easily moving the IP terminal. That is, a user who has logged in the system by using the IP terminal can freely call up the setting by the user itself, a personal telephone book, etc., to use them.

As is known well, in an SIP network, an inter-terminal calls is controlled by using address information referred to as an SIP uniform resource identifier (SIP URI). The IP terminal requires the registration of its own SIP URI to the SIP network, and the IP terminal only can only make a call when the request is approved.

However, the registration of the SIP URI results in failure due to a certain reason sometimes. The IP terminal which has resulted in failure of the registration of the SIP URI is disabled to make the call to the SIP network. In the SIP, since it is recommended to leave a time interval of a certain degree in registering the SIP URI, the IP terminal which has failed in the registration has to wait the call origination to the SIP network until the next registration change comes. Further, as the number of the IP terminals increases, the cases of the failure in the registration increases, and this situation obstructs the operation of the system, so that any countermeasure is desired.

Jpn. Pat. Appln. KOKAI Publication No. 2006-229820 discloses a related technique. The technique disclosed in this document mutually converts telephone numbers between the existing network and a VoIP network, and intends to enable call origination without changing a number schedule of the existing network. However, even such a function cannot effectively respond to the failure in the registration of the SIP URI.

As mentioned above, in the existing VoIP system results in failure in registration processing of the SIP URI in some cases, and in such a case, since the IP terminal cannot make the call to the SIP network, any countermeasure is desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred system view illustrating an embodiment of a telephone system regarding the invention;

FIG. 2 is a preferred functional block diagram illustrating an example of an SIP gateway 3 of FIG. 1;

FIG. 3 is a preferred view illustrating an example of an SIP URI registration table 35a of FIG. 2;

FIG. 4 is a preferred functional block diagram illustrating an example of a private branch exchange (PBX) 4 of FIG. 1;

FIG. 5 is a preferred view for illustrating an example of a correspondence table 42a of FIG. 4;

FIG. 6 is a preferred view for explaining processing in the telephone system of FIG. 1;

FIG. 7 is a preferred view for explaining a processing of an SIP URI registration processing unit 34a;

FIG. 8 is a preferred view for explaining processing of a call control unit 31a;

FIG. 9 is a preferred view for explaining processing of an SIP call control unit 34c;

FIG. 10 is a preferred view for explaining processing of an SIP URI selection processing unit 34b;

FIG. 11 is a preferred flowchart illustrating an example of a processing procedure for selecting an SIP URI to be implemented by the SIP gateway 3; and

FIG. 12 is a preferred view illustrating another example of the registration table 35a.

### DETAILED DESCRIPTION

Various embodiments according to the invention will be described hereinafter with reference to the accompanying drawings. In general, according to one embodiment of the invention, there is provided a telephone system which achieves a voice communication by using a packet communication network, comprising a private branch exchange which accommodates a plurality of telephone terminals; a gateway device which connects the plurality of telephone terminals to the packet communication network via the private branch exchange; and a call processing server which processes calls among the telephone terminals and the packet communication network on the basis of address information to be use in the packet communication network, wherein the exchange includes a notification processing unit which notifies an origination request message including address information corresponding to a telephone terminal that is a transmitting origin to the gateway device when an origination request from telephone terminals under its own control to the packet communication network; the gateway device comprises: a registration processing unit which requires registrations of a plurality of items of address information to be used for call origination to the packet communication network; a registration management table which records the plurality of items of address information and results of registrations in the packet communication network for each item of address information; a selection processing unit which confirms the results of the registrations of the address information included in the notified origination request message in the packet communication network by referring to the registration management table and selects another item of address information from the registration management table if the relevant address information has not been registered in the packet communication network; and a call control unit which sends a call connection request message including address information if the address information included in the origination request message has been registered in the packet communication network, and otherwise, including another item of the information selected from the selection processing unit to the call processing server.

### First Embodiment

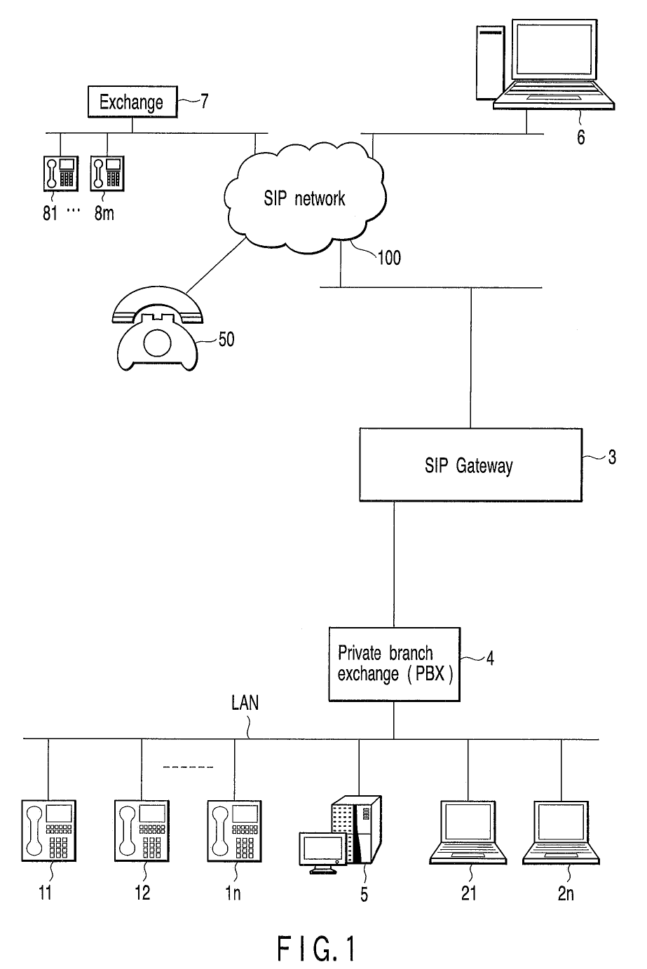

FIG. 1 is a system view illustrating an embodiment of a telephone system regarding the invention. In FIG. 1, a plurality of IP terminals 11-1n, 5, and 21-2n are interconnected via a local area network (LAN) to form a private telephone network. The IP terminals 11-1n are, for example, telephones for communication use only. IP terminal 5 is, for example, so-called software phone in which voice communication software is installed in a personal computer. The IP terminals 21-2n are also may be included in a category of the software phone, however; they function as user interfaces cooperating with the IP terminals 11-1n in some systems.

The IP terminals 11-1n, 5, and 21-2n are accommodated in a private branch exchange (PBX) 4 via the LAN. The exchange 4 controls not only extension calls of inter-IP terminal 11-1n, 5 and 21-2n but also external calls concerning each IP terminal 11-1n, 5 and 21-2n. This exchange 4 is connected to an SIP gateway 3.

The SIP gateway 3 is connected to the SIP network 100. The SIP gateway 3 converts protocols between the SIP network 100 and the LAN to connect the IP terminals 11-1n, 5 and 21-2n to the SIP network 100. A fixed telephone 50 and another private network belong to the SIP network 100, and a private branch exchange 7 and telephones 81-8m belong to the private telephone network. An SIP server 6 controls calls related to the SIP network 100 on the basis of SIP URIs.

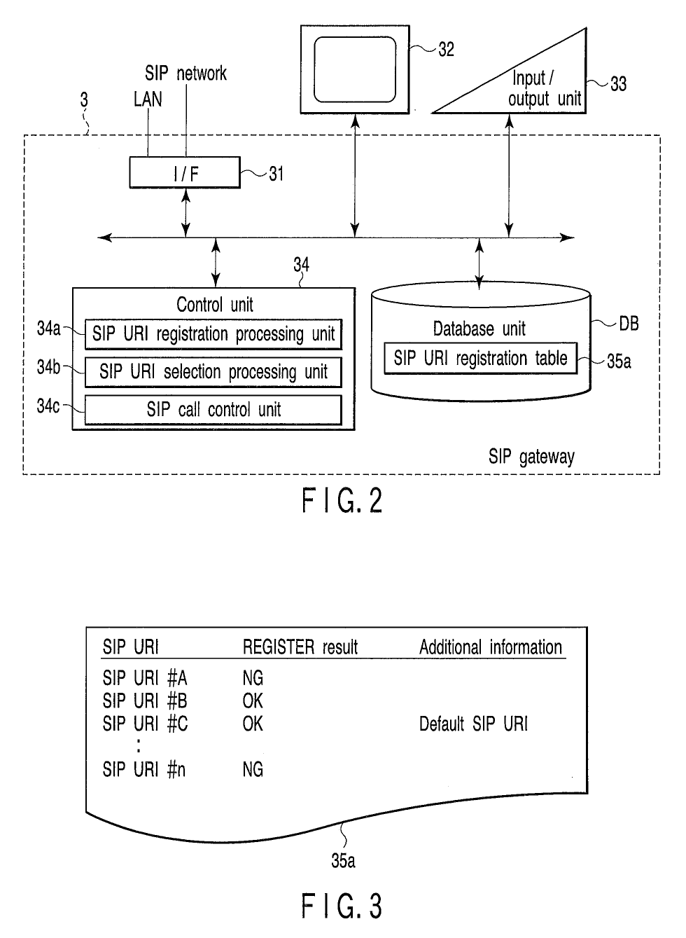

FIG. 2 is a functional block diagram illustrating an example of the SIP gateway 3 of FIG. 1. The SIP gateway 3 has an interface unit 31 to be connected to the LAN and the SIP network 100, and a display unit 32 and an input/output unit 33 to be user interfaces. In addition, the SIP gateway 3 has a control unit 34 including a database unit DB that is a storage device such as a hard disk drive and a central processing unit (CPU). Among of them, the database unit DB stores an SIP URI registration table 35a as the information concerning the invention in its storage area.

FIG. 3 is a view illustrating an example of the SIP URI registration table 35a of FIG. 2. The table 35 is one in which the possibilities of registrations in the SIP network 100 are associated with a plurality of SIP URIs, respectively. As is well known, the SIP URIs of the number corresponding to the scale of a network requesting to be connected to the SIP network 100 are provided as user accounts from the SIP network 100. However, these SIP URIs cannot be used as they are, and they become available when they are registered in the SIP network 100. To register the SIP URIs in the SIP network 100, REGISTER messages are used.

In FIG. 3, flag indicating NG as results of REGISTER are recorded in an SIP URI #A and an SIP URI #n. Therefore, if any IP terminal makes a call by using the SIP URI #A or SIP URI #n, the IP terminal cannot be connected to the SIP network 100. The fact that an SIP URI #C is a default SIP URI is recorded as additional information. The additional information will be described in the description on FIG. 10 later.

In FIG. 2, the control unit 34 has an SIP URI processing unit 34a, an SIP URI selection processing unit 34b, and an SIP call control unit 34c as processing functions related to the embodiment. The processing unit 34a requires registrations for each of the SIP URIs #A-An of FIG. 3 to the SIP network 100 by the use of the REGISTER message. The fact whether the registrations have completed successfully or not is recorded as OK or NG in the table 35a.

When receiving the call origination request to the SIP network 100, the processing unit 34b confirms the results of the registrations of the SIP URIs of the transmitting origin included in the request message with reference to the table 35a. If the REGISTER result of the SIP URI of the transmitting origin shows NG, the processing unit 34b selects another SIP URI as a substitute.

The control unit 34c sends an INVITE message including the SIP URI selected by the processing unit 34b as the address of the transmitting origin to the SIP server 6 of the SIP network 100. In other words, if the registration of the SIP URI of the transmitting origin has resulted in OK, the control unit 34c sets the SIP URI as it is in the INVITE message. However, the control unit 34c sets the substitute SIP URI in the INVITE message to the origination request from the transmitting origin of which the registration has resulted in NG.

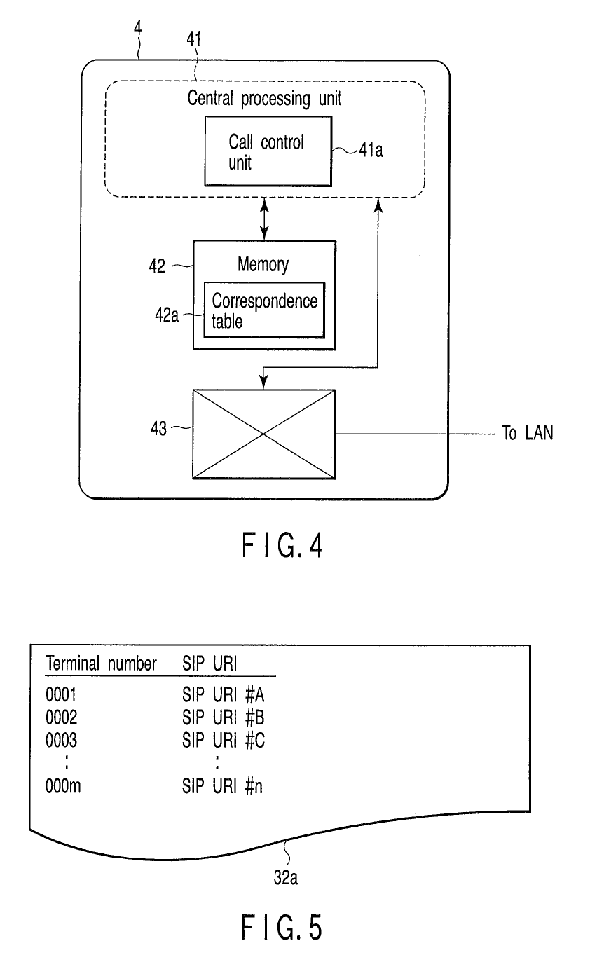

FIG. 4 is a functional block diagram illustrating an example of the exchange 4 of FIG. 1. The exchange 4 includes a switch unit 43 which is connected to the LAN and exchanges packets concerning the IP terminals 11-1n, 5 and 21-2n, a central processing unit (CPU) 41, and a memory 42. The memory 42 stores a correspondence table 42a in addition to program data necessary for each kind of control by the CPU 41.

FIG. 5 is a view illustrating an example of the table 42a in FIG. 4. This table 42a is one in which the SIP URIs to be used in origination are associated with terminal numbers of each terminal. The terminal numbers are numerical values of, for example, four digits to be used as extension numbers in the extension telephone network. They are used to uniquely specify the IP terminals 11-1n, 5, and 21-2n.

The CPU 41 of FIG. 4 has a call control unit 41a. When a request for call origination to the SIP network 100 is made from the IP terminals 11-1n, 5, and 21-2n being under the control by the exchange 4, the call control unit 41a acquires the SIP URI corresponding to the IP terminal that is the transmitting origin from the table 42a. The control unit 41a notifies a call origination request message including the acquired SIP URI to the SIP gateway 3. That is, the exchange 4 has a function to convert the dial number of the transmitting origin into an SIP URI. Next to this, operations of the foregoing configuration will be described.

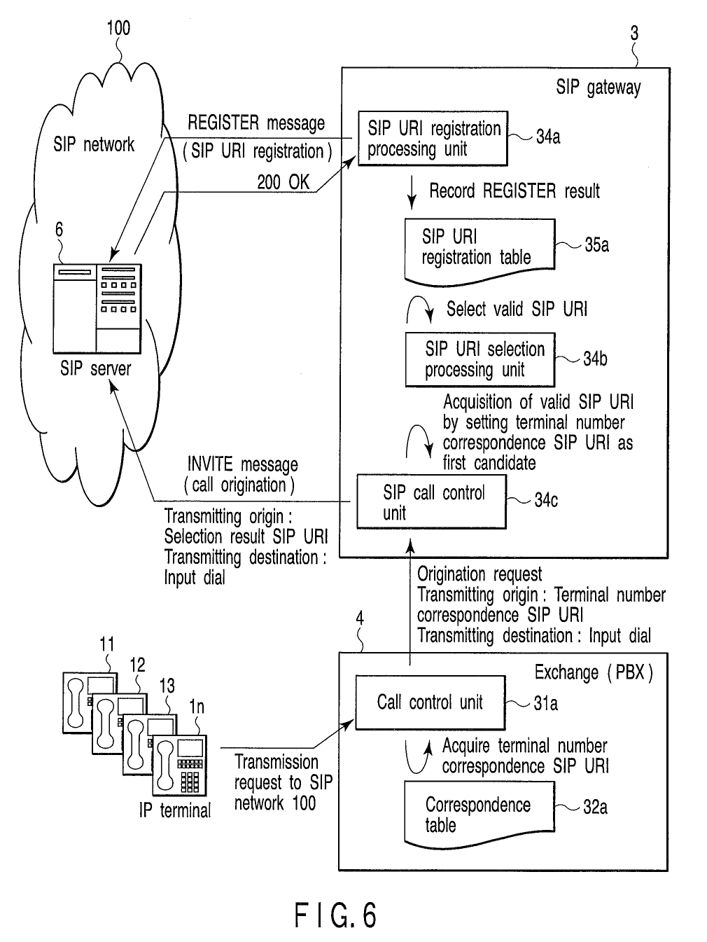

FIG. 6 is a view for explaining the processing of the telephone system in FIG. 1. In FIG. 6, the processing unit 34a of the gateway 3 periodically requires the registrations of the SIP URIs to the SIP network 100. As shown in FIG. 7, the processing unit 34a sends the registration requests of the SIP URIs #A-#n toward the SIP network 100 by using the REGISTER message. If 200 OK is returned as a response message for the requests, the processing unit 34a records the registration results of the SIP URIs, which have been required to be registered, as OK in the table 35a. If error messages of number 400 levels (4XX), number 500 levels (5XX), or number 600 levels (6XX) are returned or time is up, the processing unit 34a records the registration results as NG.

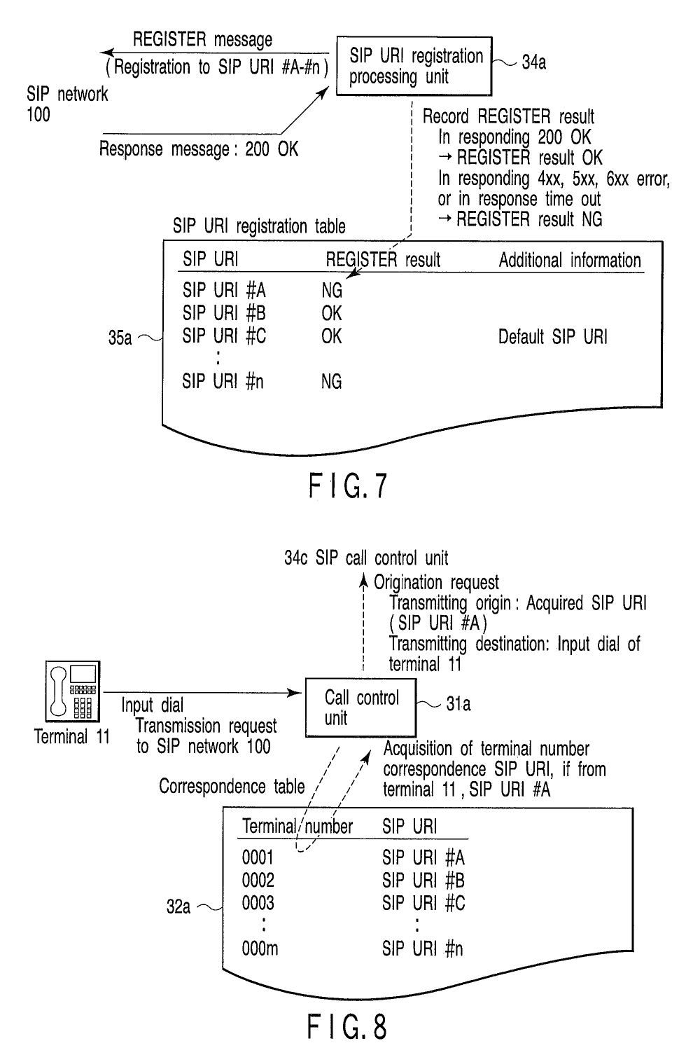

In succession, in FIG. 6, it is presumed, for example, that an origination request is made from the IP terminal 11 (terminal number is set to 0001) to the SIP network 100. The control unit 31a of the exchange 4 then, as depicted in FIG. 8, acquires the SIP URI #A corresponding to the terminal number of the IP terminal 11 to send the origination request to the gateway 3. The obtained SIP URI is set in a transmitting origin field of the transmitting origin, and an input dial number, namely a telephone number of a destination is set in the transmitting destination field.

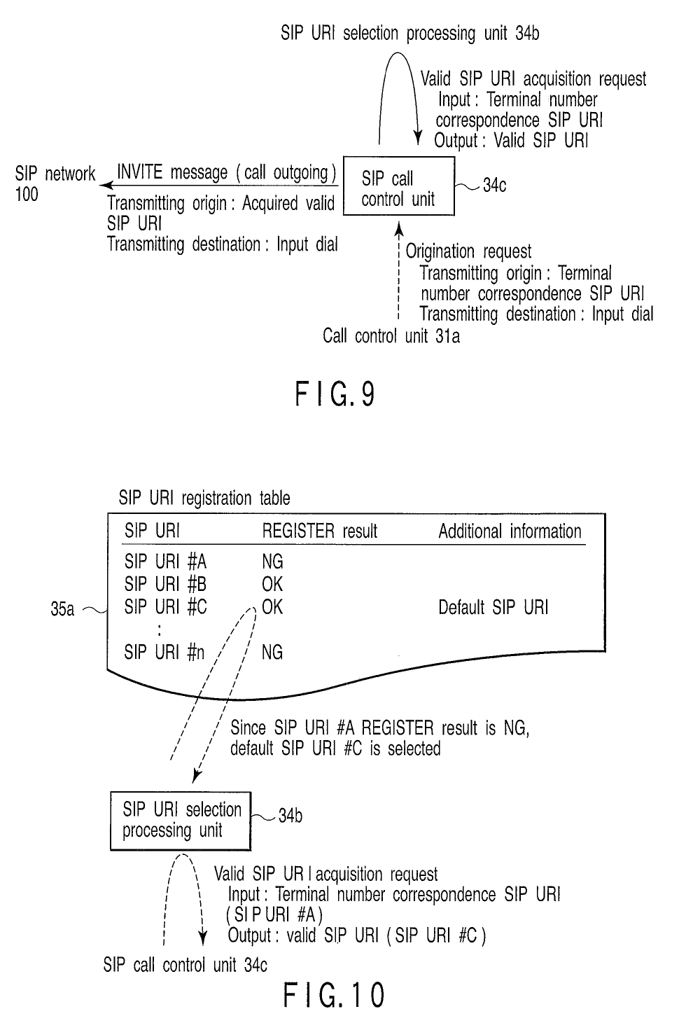

The control unit 34c of the gateway 3 with the origination request received therein requires acquiring a valid SIP URI to the processing unit 34b. At this moment, the call unit 34c makes the SIP URI corresponding to the terminal number (namely, URI set in origination request) a first candidate. As depicted in FIG. 9, when the SIP URI corresponding to the terminal number is input to the processing unit 34b, a valid SIP URI is output. When receiving the SIP URI, the control unit 34c sends the INVITE message to the SIP network 100. The acquired valid SIP URI is set in the transmitting origin field pf the INVITE message, and the acquired valid SIP URI is set to the transmitting destination field.

FIG. 10 is a view for explaining the processing in the processing unit 34b. When acquisition of the valid SIP URI is required from the control unit 34c, the processing unit 34b refers to the table 35a. The SIP URI #A corresponding to the terminal number of the IP terminal 11 (0001) becomes the input key, and the processing unit 34b confirms the REGISTER result of the SIP URI #A. Since the resulting confirmation shows NG, in the first embodiment, the SIP URI #C that is the default SIP URI is selected. In other words, the default SIP URI is one to be selected as a substitute when an origination request is made by means of the SIP URI the registration result of which is NG. The table 35a has a (additional information) section to add such an attitude to the arbitrarily selected SIP URI.

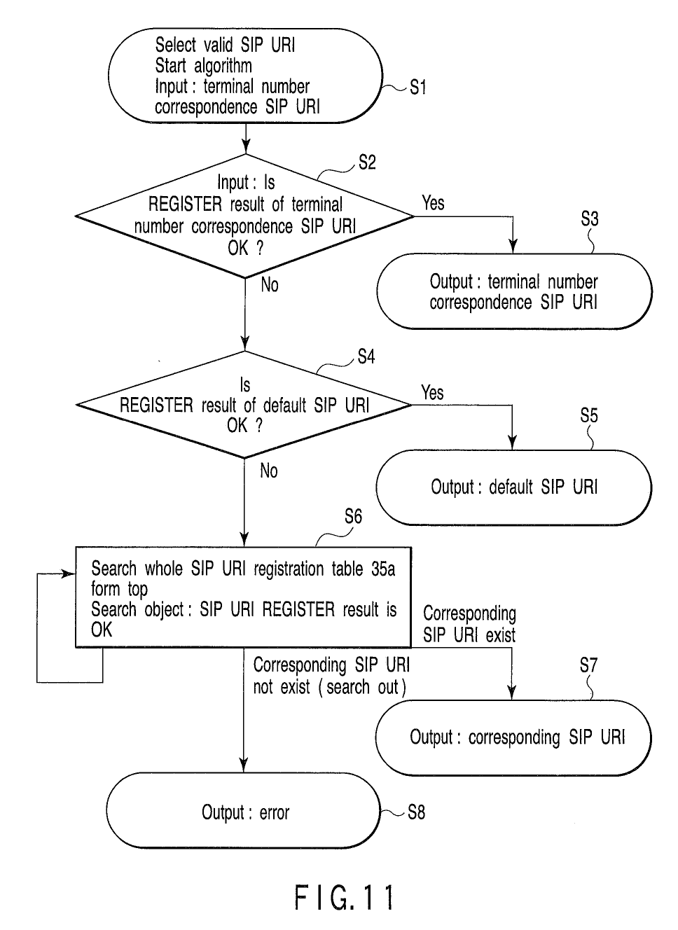

FIG. 11 is a flowchart depicting an example of a processing procedure to be implemented at the SIP gateway 3 and to select the SIP URI. The procedure is referred to as a valid SIP URI selection algorithm. In FIG. 11, when the SIP URI corresponding to the terminal number is input to the gateway 3, the selection algorithm is started (block S1). The gateway 3 then confirms whether or not the result of the REGISTER of the input SIP URI corresponding to the terminal number is OK (block S2). If it is OK, the SIP URI corresponding to the terminal number is output as it is (block S3).

If it is NG, in the next procedure the gateway 3 confirms the result of the registration of the default SIP URI itself (block S4). That is, even the default SIP URI, the registration in the SIP network 100 does not always complete successfully. This is because the default SIP URI has been decided before registration processing in many cases. In this block S4, the confirmation results in YES, the default SIP URI is output as the result of the selection process (block S5).

If the registration result of the default SIP URI is also NG (NO in block S4), the gateway S3 searches the SIP URI registration table 35a in turn from the top to find the SIP URI the registration result of which is OK (block S6). If the SIP URI the registration result of which is OK is found, the found SIP URI is output (block S7). Otherwise, an error is output as the result of the selection (block S8).

As mentioned above, according to the first embodiment, the telephone system which needs to register for each SIP URI supplied from the SIP network 100 registers the results of the registrations in the table 35a for each SIP URI. When the origination request from the extension network of the exchange 4 to the SIP network 100, the system confirms, by means of the table 35a, whether or not the SIP URIs included in the request have been already registered. At this time, if the registration results are NG, the system uses the specified SIP URI for use in the default as the substitute of the SIP URI included in the request and makes an outgoing call.

As such processing, even when a call is made from the IP terminal of which the SIP URI has failed to be registered, since the system may use the alternative SIP URI, there is no such a case that the origination itself becomes impossible. Moreover, since the first embodiment has been configured to retrieve another SPI URI if the default SIP URI has resulted in registration NG, the certainty of the connection to the SIP network 100 may be enhanced. Accordingly, the invention may provide the telephone system and the gateway device configured to surely transmit to the SIP network 100.

### Second Embodiment

The second embodiment of the invention discloses a method for effectively use the additional information stored in the SIP URI registration table 35a.

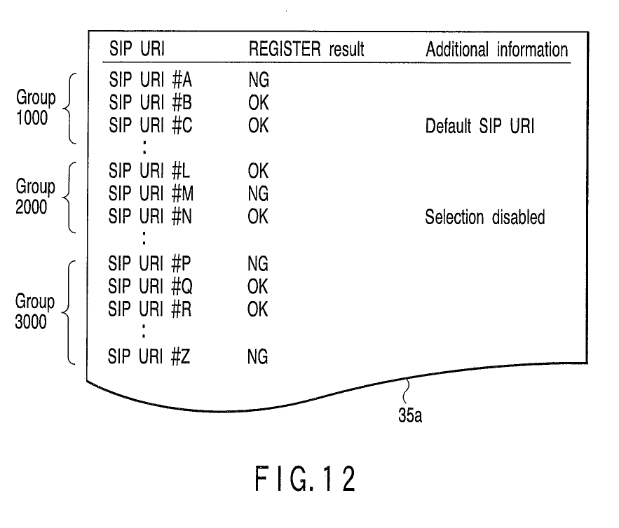

FIG. 12 is a view depicting another example of the table 35a. In the table 35a of FIG. 12, the SIP URIs are divided into a plurality of groups. For instance, the SIP URIs #A-#c belong to a group 1,000. The SIP URIs #L-#N belong to a group 2,000. The SIP URIs #P-#R belong to group 3,000.

For example, in FIG. 1, although the IP terminals 11-1n, 5, and 21-2n are installed in the same building, it is presumed that the terminals are owned by different tenants, respectively. In this case, it is preferable for a plurality of SIP URIs to be grouped by associating with each tenant. To search the alternative SIP URI, the system is configured so that the alternative SIP URI can be retrieved only in the same group. For example, as for an alternative SIP URI of the SIP URI #A, only the SIP URI #B or SIP #C belonging to the same group 1,000 can be available. Thereby, the system may enhance the confidentiality of the information for each tenant. The processing given above may be easily achieved by those skilled in the art by changing the program to achieve the SIP URI selection processing unit 34b.

In FIG. 12, a “selection disabled” flag has been set as additional information to the SIP URI #N. This means that it is prohibited to use the SIP URI #N as the alternative SIP URI in any case. Thereby, the SIP URI #N is concealed from a user who is not the user of the IP terminal, namely the use of the IP terminal having no extension number corresponding to the SIP URI #N. Accordingly, the system enables achieving the needs of the user the SIP URI of which is not desired to be used by other users. Like this, various options may be added to the additional information in the SIP URI registration table 35a. Thereby, the system may respond to a large variety of user's needs.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system which achieves a voice communication by using a packet communication network, comprising
a private branch exchange which accommodates a plurality of telephone terminals;
a gateway device which connects the plurality of telephone terminals to the packet communication network via the private branch exchange; and
a call processing server which processes calls among the telephone terminals and the packet communication network on the basis of address information to be use in the packet communication network, wherein
the exchange includes a notification processing unit which notifies an origination request message including address information corresponding to a telephone terminal that is a transmitting origin to the gateway device when an origination request from telephone terminals under its own control to the packet communication network;
the gateway device comprises:
a registration processing unit which requires registrations of a plurality of items of address information to be used for call origination to the packet communication network;
a registration management table which records the plurality of items of address information and results of registrations in the packet communication network for each item of address information;
a selection processing unit which confirms the results of the registrations of the address information included in the notified origination request message in the packet communication network by referring to the registration management table and selects another item of address information from the registration management table if the relevant address information has not been registered in the packet communication network; and
a call control unit which sends a call connection request message including address information if the address information included in the origination request message has been registered in the packet communication network, and otherwise, including another item of the information selected from the selection processing unit to the call processing server.

2. The telephone system according to claim 1, wherein the selection processing unit selects a specified item of address information as the other item of address information.

3. The telephone system according to claim 1, wherein
the plurality of items of address information are divided into a plurality of groups in the registration management table; and
the selection processing unit selects the other item of address information among address information belonging to the same group as that of the telephone terminal of the transmitting origin.

4. The telephone system according to claim 1, wherein
the packet communication network is an Internet protocol network which can use a session initiation protocol; and
the address information is an session initiation protocol uniform resource identifier to be used in accordance with the session initiation protocol.

5. A gateway device which connects a plurality of telephone terminals to a packet communication network including a call processing server which processes calls on the basis of address information, comprising:
a registration processing unit which requires registrations of a plurality of items of address information to be used for call origination to the packet communication network;
a registration management table which records the plurality of items of address information and results of registrations for each item of address information in the packet communication network;
a selection processing unit which confirms the results of the registrations of the address information included in the notified origination request message from a telephone terminal that is a transmitting origin in the packet communication network by referring to the registration management table and selects another item of address information from the registration management table if the relevant address information has not been registered in the packet communication network; and
a call control unit which sends a call connection request message including address information if the address information included in the origination request message has been registered in the packet communication network, and otherwise, including another information selected from the selection processing unit to the call processing server.

6. The gateway device according to claim 5, wherein the selection processing unit selects a specified item of address information as the other item of address information.

7. The gateway device according to claim 5, wherein
the plurality of items of address information are divided into a plurality of groups in the registration management table; and
the selection processing unit selects the other item of address information among address information belonging to the same group as that of the telephone terminal of the origination terminal.

8. The gateway device according to claim 1, wherein
the packet communication network is an Internet protocol network which can use a session initiation protocol; and
the address information is an session initiation protocol uniform resource identifier to be used for the session initiation protocol.
